(19) United States
(12) Patent Application Publication
(10) Pub. No.: US 2025/0225538 A1
(43) Pub. Date: Jul. 10, 2025

(54) METHODS AND SYSTEMS FOR STREAMLINING MARKETING CAMPAIGN MANAGEMENT

(71) Applicant: Martonomy, Inc., Sandy Springs, GA (US)

(72) Inventor: Love Hudson-Maggio, Sandy Springs, GA (US)

(21) Appl. No.: 19/010,603

(22) Filed: Jan. 6, 2025

Related U.S. Application Data
(60) Provisional application No. 63/618,634, filed on Jan. 8, 2024.

(51) Int. Cl. G06Q 30/0201; G06F 21/31; G06Q 30/01; G06Q 30/0242

(52) U.S. Cl. CPC G06Q 30/0201; G06F 21/31; G06Q 30/01; G06Q 30/0242

(57) ABSTRACT

A method for managing marketing taxonomy may comprise receiving marketing campaign data from a user by a computing device. The marketing campaign data may be stored in a structured database. A marketing taxonomy may be generated based on the stored marketing campaign data. The marketing taxonomy may be integrated with at least one external customer relationship management (CRM) system. User interaction patterns with the marketing taxonomy may be analyzed. Automated data entry suggestions may be provided based on the analyzed user interaction patterns. A customizable analytics dashboard may be generated based on the marketing taxonomy and the integrated CRM data.

### RELATED APPLICATION

Under provisions of 35 U.S.C. § 119 (e), the Applicant claims the benefit of U.S. Provisional Application No. 63/618,634 filed on Jan. 8, 2024, which is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to marketing campaign management systems. More specifically, the disclosure pertains to an integrated platform for synchronizing and managing marketing campaigns across multiple cloud-based services.

### BACKGROUND

Marketing teams may face challenges in managing and tracking their campaign data effectively. Conventional systems in this field may rely heavily on spreadsheet-based solutions for organizing marketing taxonomy and campaign progression. These traditional methods may be prone to data inconsistencies and may lack robust integration capabilities with various marketing platforms.

The use of spreadsheets for tracking campaign data may lead to potential issues with data accuracy and version control. Marketing professionals may struggle to maintain a centralized repository of campaign information, which may result in fragmented data across multiple files or platforms. This fragmentation may hinder the ability to gain comprehensive insights from marketing efforts.

Furthermore, existing solutions may not provide seamless onboarding processes for new team members or clients. The learning curve associated with complex spreadsheet systems may impede productivity and may increase the likelihood of errors in data entry and management.

Traditional methods may also face limitations in terms of scalability and flexibility. As marketing campaigns grow in complexity and volume, spreadsheet-based systems may become unwieldy and may not efficiently accommodate the expanding needs of marketing teams.

Additionally, conventional approaches may lack robust analytics integration capabilities. Marketing professionals may find it challenging to connect campaign data directly with analytics platforms, potentially leading to delays in decision-making and difficulties in measuring campaign performance accurately.

The management of UTM codes, which are crucial for tracking the effectiveness of digital marketing efforts, may be cumbersome and error-prone when relying on manual processes or disparate tools. This may result in inconsistent tracking and incomplete attribution of marketing activities.

Moreover, traditional systems may not offer adequate solutions for preserving institutional knowledge and insights from previous campaigns. The loss of valuable marketing data due to employee turnover or changes in partnerships may pose significant challenges to maintaining continuity in marketing strategies.

In addition to the challenges mentioned earlier, marketing teams may encounter difficulties in maintaining consistent naming conventions and taxonomies across different campaigns and channels. This inconsistency may lead to confusion and may hinder the ability to compare and analyze data effectively across various marketing initiatives.

The lack of a standardized system for categorizing and tagging marketing assets may result in inefficient resource allocation and may impede the reuse of successful campaign elements. Marketing professionals may struggle to quickly locate and repurpose high-performing content, potentially leading to unnecessary duplication of efforts and increased costs.

Furthermore, traditional methods may not adequately address the need for real-time collaboration among team members, especially in remote work environments. The inability to simultaneously access and update campaign information may lead to delays in decision-making and may hinder agile marketing strategies.

Another challenge that marketing teams may face is the difficulty in tracking and managing the performance of influencer marketing campaigns. Conventional systems may lack specialized features for monitoring influencer-specific metrics, making it challenging to assess the return on investment for these increasingly popular marketing initiatives.

Additionally, marketing professionals may struggle with efficiently managing and optimizing their advertising budgets across multiple platforms and channels. The absence of a centralized system for budget allocation and performance tracking may result in suboptimal resource distribution and may limit the overall effectiveness of marketing efforts.

Moreover, existing solutions may not provide adequate support for localization and internationalization of marketing campaigns. Marketing teams operating in global markets may face challenges in adapting their strategies and content to different regions while maintaining consistency in branding and messaging.

The management of digital assets, such as images, videos, and other multimedia content, may also pose significant challenges when using traditional spreadsheet-based systems. Marketing professionals may struggle to organize, tag, and retrieve these assets efficiently, potentially leading to lost opportunities and decreased productivity.

Furthermore, some existing solutions may attempt to address these challenges through specialized marketing management software. However, these platforms may often be complex and may require extensive training for effective use. The learning curve associated with such systems may deter adoption and may lead to inconsistent usage across marketing teams.

Some current solutions may offer limited customization options, which may not adequately cater to the unique needs of different marketing teams or industries. This lack of flexibility may result in workarounds or the continued use of supplementary spreadsheets, potentially negating the benefits of a centralized system.

Another approach in the market may involve the use of project management tools adapted for marketing purposes. While these tools may offer some benefits in terms of task organization and collaboration, they may lack the specific features required for comprehensive marketing taxonomy management and campaign tracking.

Certain existing platforms may focus primarily on social media management, neglecting other crucial aspects of marketing campaigns. This narrow focus may force marketing teams to juggle multiple tools, potentially leading to data silos and inefficiencies in cross-channel campaign management.

Some solutions may offer robust analytics capabilities but may fall short in providing user-friendly interfaces for data entry and management. This disparity may result in marketing professionals spending excessive time on data input rather than focusing on strategic analysis and decision-making.

Additionally, current systems may not adequately address the need for version control and audit trails in marketing data management. This limitation may pose challenges in tracking changes, identifying errors, and maintaining accountability within marketing teams.

The integration of artificial intelligence and machine learning capabilities in existing marketing management solutions may be limited or non-existent. This lack of advanced technology may hinder the ability to automate routine tasks, generate predictive insights, and optimize campaign performance in real-time.

Moreover, some current platforms may not provide adequate support for managing the entire marketing lifecycle, from ideation to execution and post-campaign analysis. This fragmentation may result in disjointed workflows and may impede the ability to gain holistic insights into marketing performance.

The need for an improved solution in marketing campaign management arises from the limitations of existing systems. Current approaches may struggle to provide a comprehensive, integrated platform that addresses the multifaceted challenges faced by marketing teams. These challenges may include data inconsistencies, lack of scalability, inefficient collaboration, and inadequate support for the entire marketing lifecycle. A solution that can overcome these obstacles may be beneficial for enhancing marketing efficiency, improving data accuracy, and facilitating more informed decision-making in campaign management.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In some embodiments, a method for managing marketing taxonomy may be provided. The method may include receiving, by a computing device, marketing campaign data from a user. The marketing campaign data may be stored in a structured database. A marketing taxonomy may be generated, by the computing device, based on the stored marketing campaign data. The marketing taxonomy may be integrated with at least one external customer relationship management (CRM) system. User interaction patterns with the marketing taxonomy may be analyzed, by the computing device. Automated data entry suggestions may be provided, by the computing device, based on the analyzed user interaction patterns. A customizable analytics dashboard may be generated, by the computing device, based on the marketing taxonomy and the integrated CRM data.

In other embodiments, a non-transitory computer-readable medium storing instructions may be provided. When executed by a processor, the instructions may cause the processor to perform operations. The operations may include receiving marketing campaign data from a user. The marketing campaign data may be stored in a structured database. A marketing taxonomy may be generated based on the stored marketing campaign data. The marketing taxonomy may be integrated with at least one external customer relationship management (CRM) system. User interaction patterns with the marketing taxonomy may be analyzed. Automated data entry suggestions may be provided based on the analyzed user interaction patterns. A customizable analytics dashboard may be generated based on the marketing taxonomy and the integrated CRM data.

In still other embodiments, a system for managing marketing taxonomy may be provided. The system may include a cloud-based software platform, a database configured to store marketing taxonomy data, a user interface configured to receive user input for creating and managing marketing campaigns, an integration module configured to connect with external customer relationship management (CRM) systems, a machine learning component configured to analyze user interaction patterns and provide automated data entry suggestions, a dashboard generator configured to create customizable visualizations of marketing data, and a processor. The processor may be configured to receive marketing campaign data from the user interface. The marketing campaign data may be stored in the database. The marketing campaign data may be synchronized with the connected external CRM systems. The marketing campaign data may be analyzed using the machine learning component. Automated data entry suggestions may be generated based on the analysis. Customized dashboards displaying marketing campaign performance metrics may be generated.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment for a marketing campaign management platform consistent with the present disclosure;

FIG. 2 is a flow chart of a method for providing a marketing campaign management platform;

FIG. 3 is an example dashboard produced by the marketing campaign management platform; and

FIG. 4 is a block diagram of a system including a computing device for performing the method of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one”, but does not exclude a plurality unless the contextual use dictates otherwise. When used herein to join a list of items, “or” denotes “at least one of the items”, but does not exclude a plurality of items of the list. Finally, when used herein to join a list of items, and denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in, the context of a marketing campaign management platform, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The present disclosure addresses a technical problem in the field of marketing campaign management. Traditional methods of managing marketing taxonomies often rely on spreadsheets or disconnected systems, leading to data loss, inaccurate tracking, and inefficient collaboration. These challenges may become particularly acute as marketing campaigns grow in complexity and scale.

In one example, a marketing team may be managing multiple campaigns across various channels, each with its own set of metrics and targeting parameters. Using spreadsheets to track this information may result in version control issues, data entry errors, and difficulty in generating comprehensive analytics. For instance, a team member may accidentally overwrite important campaign data in a shared spreadsheet, or crucial information may be lost when an employee leaves the organization.

Another scenario may involve a marketing department struggling to integrate data from multiple customer relationship management (CRM) systems. This fragmentation may lead to incomplete views of customer interactions and campaign performance, hindering the ability to make data-driven decisions. For example, a company using both Salesforce and HubSpot may find it challenging to create a unified marketing taxonomy that incorporates data from both platforms.

In yet another example, a global marketing team may face difficulties in maintaining consistent taxonomy across different regions or product lines. Without a centralized system, each team may develop its own nomenclature and categorization methods, making it challenging to compare performance or share insights across the organization.

To address these challenges, the present disclosure may provide a marketing taxonomy management platform. This platform may offer a centralized, cloud-based solution for creating, organizing, and analyzing marketing taxonomies. The platform may integrate with one or more external CRM systems, allowing for seamless data synchronization and a holistic view of marketing efforts.

The platform may include a user interface for inputting and managing marketing campaign data. This interface may be designed to be intuitive and user-friendly, reducing the learning curve for new users and minimizing data entry errors. The platform may store the inputted data in a structured database, ensuring data integrity and facilitating complex queries and analysis.

In some embodiments, the platform may employ machine learning algorithms to analyze user interaction patterns with the marketing taxonomy. Based on this analysis, the system may provide automated data entry suggestions, potentially saving time and reducing errors. For example, if a user frequently categorizes email campaigns targeting a specific customer segment under a particular taxonomy node, the system may suggest this categorization for future similar campaigns.

The platform may also generate a customizable analytics dashboard based on the marketing taxonomy and integrated CRM data. This dashboard may provide real-time insights into campaign performance, allowing marketers to make data-driven decisions quickly. Users may have the ability to customize the dashboard views according to their specific needs and preferences.

To enhance collaboration and data consistency, the platform may implement a user authentication and access control system. This system may manage user accounts and permissions, ensuring that team members have appropriate access to the marketing taxonomy while maintaining data security.

The platform may also include features for generating and tracking Urchin Tracking Module (UTM) codes for marketing campaigns. These codes may be associated with specific marketing taxonomy elements, allowing for granular tracking of campaign performance across different channels and initiatives.

By providing a comprehensive solution for marketing taxonomy management, the present disclosure may address the technical problems associated with traditional methods. The platform may enable more efficient collaboration, reduce data loss and errors, and provide deeper insights into marketing campaign performance.

The operating environment for enabling the embodiments of the present disclosure may include a cloud-based infrastructure. This infrastructure may comprise multiple interconnected servers and data centers distributed across various geographical locations. The servers may be configured to host the marketing taxonomy management platform and handle user requests, data processing, and storage.

The platform may be designed to operate on various operating systems, including but not limited to Linux, Windows Server, and macOS. These operating systems may be installed on physical servers or virtual machines within the cloud infrastructure. Virtualization technologies such as VMware or Hyper-V may be employed to optimize resource utilization and provide scalability.

A robust network infrastructure may be implemented to ensure high availability and low latency for users accessing the platform. This may include load balancers, content delivery networks (CDNs), and redundant network paths to distribute traffic efficiently and minimize downtime.

The platform may utilize a distributed database system to store and manage marketing taxonomy data. This database system may be designed to handle large volumes of structured and unstructured data, providing fast read and write operations. Popular database technologies such as PostgreSQL, MongoDB, or Cassandra may be employed based on specific requirements.

A containerization technology like Docker may be used to package the application and its dependencies, ensuring consistency across different environments and facilitating easy deployment and scaling. Container orchestration platforms such as Kubernetes may be implemented to manage the deployment, scaling, and operation of application containers across clusters of hosts.

The platform may integrate with various external systems and services. This may include customer relationship management (CRM) systems, marketing automation tools, and analytics platforms, content management system (CMS) platforms, and/or analytics tools. Application Programming Interfaces (APIs) may be developed to facilitate seamless data exchange between the platform and these external systems.

A robust security infrastructure may be implemented to protect user data and ensure compliance with relevant regulations. This may include encryption of data at rest and in transit, multi-factor authentication, regular security audits, and intrusion detection systems.

The platform may utilize a microservices architecture to enhance modularity and scalability. Each component of the system, such as the user interface, data processing engine, and integration modules, may be developed and deployed as separate services that communicate via well-defined APIs.

A caching layer may be implemented using technologies like Redis or Memcached to improve performance by reducing database load and speeding up frequently accessed data retrieval.

The platform may leverage cloud-native services provided by major cloud providers such as Amazon Web Services (AWS), Microsoft Azure, or Google Cloud Platform (GCP). These services may include managed databases, serverless computing platforms, and machine learning services to enhance the platform's capabilities and reduce operational overhead.

A continuous integration and continuous deployment (CI/CD) pipeline may be established to automate the testing and deployment processes. This may include tools like Jenkins, GitLab CI, or GitHub Actions to ensure rapid and reliable delivery of new features and updates.

The platform may be designed to support multiple client interfaces, including web browsers, mobile applications, and desktop applications. Responsive design principles may be applied to ensure a consistent user experience across various devices and screen sizes.

A robust logging and monitoring system may be implemented to track system performance, user activities, and potential issues. Tools like ELK stack (Elasticsearch, Logstash, and Kibana) or Splunk may be used for log aggregation and analysis.

The platform may utilize content delivery networks (CDNs) to cache and serve static assets, reducing latency for users accessing the platform from different geographical locations.

A disaster recovery and business continuity plan may be implemented, including regular data backups, failover mechanisms, and geographically distributed redundant systems to ensure minimal disruption in case of system failures or natural disasters.

The platform may provide a solution for managing marketing taxonomy by integrating with multiple customer relationship management (CRM) systems. This integration may allow for centralized data management, ensuring data integrity and facilitating complex queries across different marketing campaigns and customer segments.

The platform may integrate with one or more content management system (CMS) platforms. This integration may allow users to create, edit, organize, and publish digital content. The created taxonomy may allow for easy indexing search and retrieval of content within the CMS platform.

The platform may integrate with one or more analytics tools. The integration may allow users to analyze effectiveness of marketing campaigns. The created taxonomy may allow for easy indexing and search within the analytics platform.

A user-friendly interface may be implemented to minimize data entry errors and reduce the learning curve for new users. This interface may include intuitive forms, drag-and-drop functionality, and visual representations of the marketing taxonomy structure.

The platform may incorporate machine learning algorithms to analyze user interaction patterns. These algorithms may provide automated data entry suggestions based on historical data and user behavior, potentially increasing efficiency and reducing manual input errors.

A customizable analytics dashboard may be offered, providing real-time insights into campaign performance. Users may be able to configure this dashboard to display key performance indicators (KPIs) relevant to their specific marketing objectives and taxonomy structure.

The system may implement robust user authentication and access control mechanisms. These features may manage user accounts and permissions, ensuring data security and allowing for role-based access to different parts of the marketing taxonomy.

An Urchin Tracking Module (UTM) code generation and tracking feature may be included. This feature may associate UTM codes with specific taxonomy elements, enabling granular performance tracking of marketing campaigns across various channels and platforms.

The platform may operate on a cloud-based infrastructure, utilizing distributed servers and data centers. This architecture may allow for scalability, high availability, and improved performance for users accessing the system from different geographical locations.

Multiple operating systems, such as Linux, Windows Server, and macOS, may be supported to accommodate diverse IT environments and user preferences. Virtualization technologies like VMware and Hyper-V may be employed to optimize resource utilization and facilitate system management.

A robust network infrastructure with load balancers and content delivery networks (CDNs) may be implemented. This infrastructure may ensure efficient distribution of traffic and reduce latency for users accessing the platform from different regions.

The system may utilize a distributed database system, potentially incorporating technologies such as PostgreSQL, MongoDB, or Cassandra. This approach may enable efficient storage and retrieval of large volumes of marketing taxonomy data while maintaining data consistency and reliability.

The present disclosure may provide several technical advantages over traditional marketing taxonomy management methods. These advantages may stem from the platform's integrated approach, advanced data processing capabilities, and user-centric design.

One technical advantage may be the platform's ability to centralize marketing taxonomy data from multiple sources. By integrating with various external CRM systems, CMS platforms, and/or analytics tools, the platform may eliminate data silos and provide a unified view of marketing efforts. This integration may reduce data redundancy and inconsistencies that often occur when managing marketing taxonomies across disparate systems.

Another technical advantage may be the platform's use of machine learning algorithms to analyze user interaction patterns. These algorithms may enable the system to provide automated data entry suggestions, potentially reducing manual input errors and increasing efficiency. As the system learns from user behavior over time, the accuracy of these suggestions may improve, leading to a more streamlined and error-resistant data entry process.

The platform's customizable analytics dashboard may offer a significant technical advantage by providing real-time insights into campaign performance. This feature may allow marketers to make data-driven decisions quickly, potentially improving the overall effectiveness of marketing campaigns. The ability to customize dashboard views may enable users to focus on the most relevant metrics for their specific needs, enhancing the utility of the analytics provided.

The implementation of a user authentication and access control system may offer technical advantages in terms of data security and collaboration. By managing user accounts and permissions, the platform may ensure that sensitive marketing data is only accessible to authorized personnel. This feature may be particularly beneficial for large organizations with complex team structures and varying levels of data access requirements.

The platform's UTM code generation and tracking feature may provide a technical advantage by enabling granular performance tracking of marketing campaigns across various channels. By associating UTM codes with specific taxonomy elements, the system may offer deeper insights into campaign effectiveness and attribution, potentially leading to more informed marketing strategies.

The cloud-based infrastructure of the platform may offer technical advantages in terms of scalability and accessibility. This architecture may allow the system to handle increasing volumes of data and user requests as organizations grow, without requiring significant changes to the underlying infrastructure. Additionally, the cloud-based approach may enable users to access the platform from various devices and locations, facilitating collaboration among geographically dispersed teams.

The platform's use of a distributed database system may provide technical advantages in terms of data storage and retrieval efficiency. This approach may enable the system to handle large volumes of marketing taxonomy data while maintaining performance and data integrity. The ability to perform complex queries across vast datasets may enhance the platform's analytical capabilities and responsiveness.

The implementation of caching mechanisms may offer technical advantages by reducing database load and speeding up frequently accessed data retrieval. This feature may contribute to improved system performance and responsiveness, particularly for users working with large datasets or complex taxonomies.

The platform's microservices architecture may provide technical advantages in terms of modularity and maintainability. By developing and deploying components as separate services, the system may be more resilient to failures and easier to update or scale individual components without affecting the entire platform.

The use of containerization technologies may offer technical advantages in terms of consistency and portability across different environments. This approach may simplify deployment processes and ensure that the platform behaves consistently across development, testing, and production environments.

The platform's integration with cloud-native services may provide technical advantages by leveraging advanced capabilities offered by major cloud providers. This integration may enhance the platform's functionality in areas such as managed databases, serverless computing, and machine learning services, potentially reducing operational overhead and improving overall system capabilities.

The implementation of a robust logging and monitoring system may offer technical advantages in terms of system maintenance and troubleshooting. By tracking system performance, user activities, and potential issues in real-time, the platform may enable faster problem resolution and proactive system optimization.

These technical advantages may collectively contribute to a more efficient, secure, and insightful marketing taxonomy management solution, addressing many of the challenges associated with traditional methods and enabling organizations to derive greater value from their marketing data.

The platform may be used for managing marketing taxonomy, addressing the challenges faced by marketing teams in organizing, tracking, and analyzing their marketing efforts. This platform may integrate with multiple customer relationship management (CRM) systems and/or content management system (CMS) platforms, offering a centralized solution for creating, organizing, and analyzing marketing taxonomies.

The platform may feature a user-friendly interface designed to minimize data entry errors and reduce the learning curve for new users. This interface may include intuitive forms, drag-and-drop functionality, and visual representations of the marketing taxonomy structure. The system may store inputted data in a structured database, ensuring data integrity and facilitating complex queries and analysis.

In some embodiments, the platform may employ machine learning algorithms to analyze user interaction patterns with the marketing taxonomy. Based on this analysis, the system may provide automated data entry suggestions, potentially saving time and reducing errors. For example, if a user frequently categorizes email campaigns targeting a specific customer segment under a particular taxonomy node, the system may suggest this categorization for future similar campaigns.

The platform may generate a customizable analytics dashboard based on the marketing taxonomy and integrated CRM, CMS, and/or analytics data. This dashboard may provide real-time insights into campaign performance, allowing marketers to make data-driven decisions quickly. Users may have the ability to customize the dashboard views according to their specific needs and preferences, focusing on the most relevant metrics for their marketing objectives.

To enhance collaboration and data consistency, the platform may implement a user authentication and access control system. This system may manage user accounts and permissions, ensuring that team members have appropriate access to the marketing taxonomy while maintaining data security. This feature may be particularly beneficial for large organizations with complex team structures and varying levels of data access requirements.

The platform may also include features for generating and tracking Urchin Tracking Module (UTM) codes for marketing campaigns. These codes may be associated with specific marketing taxonomy elements, allowing for granular tracking of campaign performance across different channels and initiatives. This feature may offer deeper insights into campaign effectiveness and attribution, potentially leading to more informed marketing strategies.

The system may operate on a cloud-based infrastructure, utilizing distributed servers and data centers. This architecture may allow for scalability, high availability, and improved performance for users accessing the system from different geographical locations.

The platform may support multiple operating systems and employ virtualization technologies to optimize resource utilization and facilitate system management.

Embodiments of the present disclosure may comprise methods, systems, and a computer readable medium comprising, but not limited to, at least one of the following:
A. A Data Store
B. A User Interface
C. A Taxonomy Generation Module
D. An Integration Module
E. A Machine Learning Module
F. A Dashboard Generator

In some embodiments, the present disclosure may provide an additional set of modules for further facilitating the software and hardware platform. The additional set of modules may comprise, but not be limited to:
G. A Data Import/Export Module
H. A Tracking Code Management Module

Details with regards to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 400 may be employed in the performance of some or all of the stages disclosed with regard to the methods. Similarly, an apparatus may be employed in the performance of some or all of the stages of the methods. As such, the apparatus may comprise at least those architectural components as found in computing device 400.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
receiving, by a computing device, marketing campaign data from a user;
storing the marketing campaign data in a structured database;
generating, by the computing device, a marketing taxonomy based on the stored marketing campaign data;
integrating the marketing taxonomy with at least one external customer relationship management (CRM) system;
analyzing, by the computing device, user interaction patterns with the marketing taxonomy;
providing, by the computing device, automated data entry suggestions based on the analyzed user interaction patterns; and
generating, by the computing device, a customizable analytics dashboard based on the marketing taxonomy and the integrated CRM data.

Although the aforementioned method has been described to be performed by the platform 100, it should be understood that computing device 400 may be used to perform the various stages of the method. Furthermore, in some embodiments, different operations may be performed by different networked elements in operative communication with computing device 400. For example, a plurality of computing devices may be employed in the performance of some or all of the stages in the aforementioned method. Moreover, a plurality of computing devices may be configured much like a single computing device 400. Similarly, an apparatus may be employed in the performance of some or all stages in the method. The apparatus may also be configured much like computing device 400.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

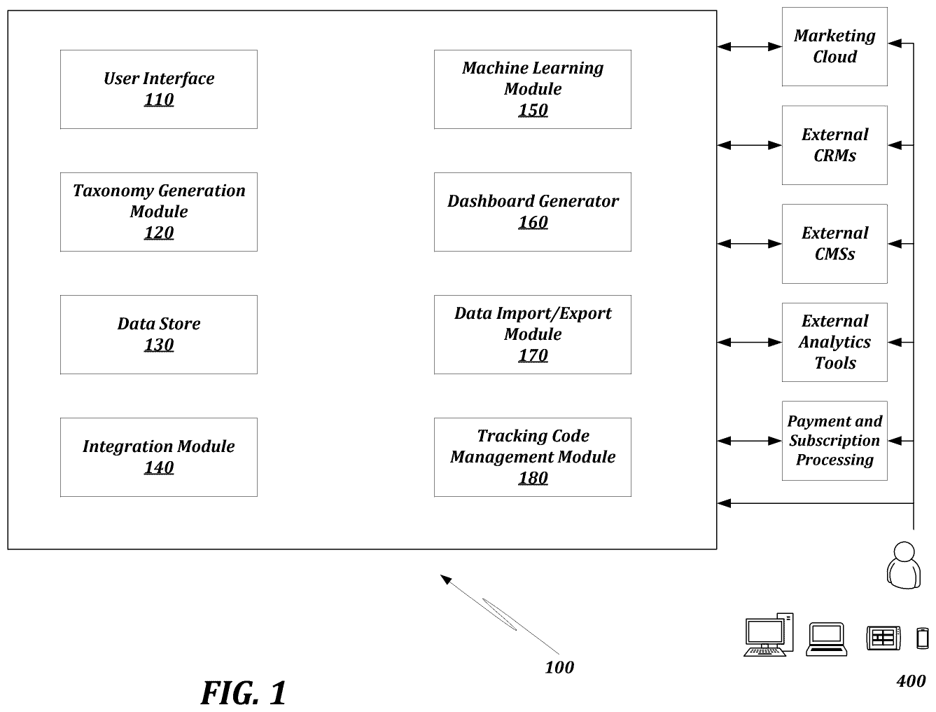

FIG. 1 illustrates one possible operating environment through which a platform consistent with embodiments of the present disclosure may be provided. By way of non-limiting example, a marketing campaign management platform 100 may be hosted on, for example, a cloud computing service. In some embodiments, the platform 100 may be hosted on a computing device 400. A user may access platform 100 through a software application and/or hardware device. The software application may be embodied as, for example, but not be limited to, a website, a web application, a desktop application, and a mobile application compatible with the computing device 400.

The operating environment for the marketing taxonomy management platform 100 may include several components and infrastructure elements to enable its technical solution. The platform 100 may be hosted on a cloud computing infrastructure, which may provide scalability, reliability, and accessibility. This cloud-based environment may utilize distributed servers and data centers to ensure high availability and performance.

The platform 100 may support multiple operating systems, including Windows, macOS, and Linux, to accommodate diverse user preferences. Virtualization technologies may be employed to optimize resource utilization and enhance system flexibility. A distributed database system may be implemented for efficient data storage and retrieval, allowing for seamless management of large volumes of marketing taxonomy data.

The system architecture may adopt a microservices approach, which may enable modularity and maintainability. This architecture may allow for independent development, deployment, and scaling of individual components. Containerization technologies, such as Docker, may be utilized to ensure consistent deployment across different environments.

Integration with cloud-native services may be incorporated to leverage advanced capabilities such as machine learning, analytics, and security features. These services may enhance functionality and/or performance of the platform 100 without requiring extensive in-house development.

A robust logging and monitoring system may be implemented to facilitate maintenance and troubleshooting. This system may provide real-time insights into the platform's performance, resource utilization, and potential issues.

The platform 100 may utilize a high-speed internet connection to ensure smooth data transfer between the cloud infrastructure and user devices. It may be designed to work with various web browsers, including (but not limited to) Chrome, Firefox, Safari, and/or Edge, to provide a consistent user experience across different platforms.

To support integration with multiple CRM systems, CMS platforms, and/or analytics tools, the platform 100 may implement standardized APIs and data exchange protocols. These may include, as non-limiting examples, RESTful APIs, GraphQL, and/or SOAP, depending on the requirements of the integrated systems.

The user interface may be developed using modern web technologies such as HTML5, CSS3, and/or JavaScript frameworks. This may help to enable a responsive design that adapts to different screen sizes and device types, including desktop computers, tablets, and smartphones.

For data security and user authentication, the platform 100 may employ industry-standard encryption protocols, such as SSL/TLS for data in transit and AES for data at rest. Multi-factor authentication may be implemented to enhance user account security.

The machine learning component of the platform 100 may require specialized hardware, such as GPUs, to efficiently process large datasets and generate real-time insights. This may be provisioned through cloud-based machine learning services or dedicated hardware instances.

To support real-time analytics and dashboard generation, the platform 100 may utilize in-memory data processing technologies and stream processing frameworks. These may enable rapid data analysis and visualization, providing users with up-to-date insights into their marketing campaigns.

Accordingly, embodiments of the present disclosure provide a software and hardware platform comprised of a distributed set of computing elements, including, but not limited to:

### A. A User Interface

The user interface 110 of the marketing taxonomy management platform 100 may include hardware and/or software configured to provide an intuitive and efficient experience for users. The interface 110 may feature a responsive layout that adapts to different screen sizes and devices.

Upon logging in, the user interface 110 may present a user with a dashboard that provides an overview of their marketing campaigns and key performance metrics. This dashboard may include customizable widgets that display real-time data visualizations, such as charts, graphs, and tables.

The main navigation menu may be located at the top or side of the screen, providing easy access to different sections of the platform. These sections may include Campaign Management, Taxonomy Editor, Analytics, Integrations, and Settings.

In the Campaign Management section, users may be able to create, edit, and manage their marketing campaigns. The interface may provide forms with clearly labeled fields for entering campaign details, such as name, description, start and end dates, budget, and target audience.

The Taxonomy Editor may feature a visual representation of the marketing taxonomy structure. Users may be able to drag and drop elements to reorganize the taxonomy, add new categories or tags, and edit existing ones. A search function may be included to quickly locate specific taxonomy elements.

The Analytics section may present users with interactive charts and graphs that visualize campaign performance data. Users may be able to filter and sort data by various parameters, such as date range, campaign type, or audience segment.

The Integrations page may display a list of available CRM systems, CMS platforms, analytics tools, and/or other marketing tools that can be connected to the platform. Users may be able to initiate the integration process with a single click and view the status of their connected systems.

Throughout the interface, contextual help tooltips may be available to provide users with additional information and guidance on specific features or functions. A global search bar may be implemented to allow users to quickly find and access specific campaigns, taxonomy elements, or analytics reports.

The user interface may also include a notification system that alerts users to important updates, such as completed data synchronizations or campaign performance milestones. These notifications may appear as pop-ups or be accessible through a dedicated notifications panel.

### B. A Taxonomy Generation Module

The taxonomy generation module 120 may include hardware and/or software configured to create, organize, and/or maintain a hierarchical structure of marketing categories, tags, and attributes that form the platform's taxonomy system.

The taxonomy generation module 120 may utilize advanced algorithms and machine learning techniques to analyze marketing campaign data stored in a structured database. The taxonomy generation module 120 may identify patterns, relationships, and commonalities among various marketing elements to create a logical and efficient taxonomy structure.

When generating a taxonomy, the module 120 may consider multiple factors, including (but not limited to) industry-specific terminology, campaign types, target audiences, marketing channels, and performance metrics. The resulting taxonomy may be flexible and scalable, allowing for easy additions, modifications, and deletions of categories and subcategories as marketing strategies evolve.

The module 120 may employ natural language processing (NLP) techniques to extract relevant keywords and phrases from campaign descriptions, ad copy, and other textual data. These extracted elements may be used to suggest appropriate taxonomy categories and tags.

To help ensure consistency and accuracy, the taxonomy generation module 120 may incorporate predefined rules and best practices for taxonomy creation. These rules may include guidelines for naming conventions, hierarchical depth, and relationships between different taxonomy elements.

The module 120 may also feature an interactive component that allows users to provide feedback and make manual adjustments to the generated taxonomy. This collaborative approach may help refine the taxonomy structure and improve its relevance to specific organizational needs.

As new marketing campaign data is added to the platform 100, the taxonomy generation module 120 may update and refine the existing taxonomy. The module 120 may suggest new categories and/or relationships based on emerging trends or changes in marketing strategies.

The taxonomy generation module 120 may integrate with external data sources and industry-standard taxonomies to enhance its knowledge base and improve the quality of generated taxonomies. This integration may allow for the incorporation of widely accepted marketing concepts and terminologies.

To facilitate seamless integration with external CRM systems, CMS platforms, and/or analytics tools, the taxonomy generation module 120 may include mapping capabilities. These capabilities may allow the generated taxonomy to be aligned with existing classification systems used in connected CRM systems, CMS platforms, and/or analytics tools.

The module 120 may generate visual representations of the taxonomy structure, such as hierarchical trees or network graphs. These visualizations may help users understand the relationships between different taxonomy elements and navigate the structure more effectively.

Performance metrics may be associated with each taxonomy element, allowing users to assess the effectiveness of different categories and tags in relation to marketing campaign outcomes. This feature may enable data-driven decisions in refining and optimizing the taxonomy structure.

The taxonomy generation module 120 may support multilingual capabilities, allowing for the creation of taxonomies in multiple languages. This feature may be particularly useful for organizations operating in global markets or managing multilingual marketing campaigns.

### C. A Data Store

The data store 130 of the marketing taxonomy management platform 100 may include hardware and/or software designed to efficiently handle large volumes of structured and unstructured marketing data. This component may be responsible for storing, organizing, and retrieving various types of information related to marketing campaigns, taxonomies, user interactions, and/or analytics.

The data store 130 may utilize a distributed database system to ensure scalability and high performance. This system may be capable of handling concurrent read and write operations from multiple users and integrated systems.

To optimize data retrieval and analysis, the data store 130 may implement both relational and non-relational database models. The relational database may be used for storing structured data with well-defined relationships, such as campaign details, user information, and taxonomy structures. The non-relational database may be employed for handling unstructured or semi-structured data, including user interaction logs and raw analytics data.

The data store 130 may incorporate data partitioning and sharding techniques to distribute data across multiple servers or nodes. This approach may improve query performance and enable horizontal scaling as the volume of data grows.

To ensure data integrity and consistency, the data store 130 may implement ACID (Atomicity, Consistency, Isolation, Durability) properties for critical transactions. This may be particularly important for operations involving financial data or campaign status updates.

The data store 130 may include a caching layer to reduce database load and improve response times for frequently accessed data. This caching mechanism may utilize in-memory data stores, such as Redis or Memcached, to store and retrieve frequently accessed information quickly.

To support real-time or near real-time analytics and reporting, the data store 130 may implement a time-series database component. This may allow for efficient storage and querying of time-stamped data, such as campaign performance metrics over time.

The data store 130 may include a robust backup and recovery system to protect against data loss. This system may perform regular backups and support point-in-time recovery options to minimize downtime in case of system failures.

To facilitate data integration with external CRM systems, CMS platforms, and/or analytics tools, the data store 130 may implement a flexible schema design that can accommodate various data formats and structures. This may include support for JSON or XML data types to store semi-structured data from different sources.

The data store 130 may incorporate data versioning capabilities to track changes in marketing taxonomies and campaign structures over time. This feature may enable users to review historical data and revert to previous versions if needed.

To support machine learning and predictive analytics features, the data store 130 may include specialized data structures optimized for efficient model training and inference. This may involve storing pre-computed features or model parameters to improve performance.

### D. An Integration Module

The integration module 140 of the marketing taxonomy management platform 100 may include hardware and/or software configured to facilitate seamless data exchange and functionality integration with external customer relationship management (CRM) systems, content management system (CSM) platforms, analytics tools, and other marketing tools. This module 140 may play a crucial role in centralizing marketing data and enhancing the platform's 100 overall functionality.

The integration module 140 may utilize standardized application programming interfaces (APIs) to establish connections with various external systems. These APIs may include RESTful interfaces, GraphQL, or SOAP protocols, depending on the requirements of the integrated systems.

To ensure secure data transfer, the integration module 140 may implement robust encryption protocols, such as SSL/TLS, for all communications between the platform 100 and external systems. This may help protect sensitive marketing data during transmission.

The module 140 may feature a flexible adapter architecture that allows for easy addition of new integrations without significant modifications to the core system. This modular approach may enable rapid expansion of the platform's 100 integration capabilities.

To handle data mapping and transformation between different systems, the integration module 140 may incorporate a powerful data transformation engine. This engine may be capable of converting data formats, reconciling schema differences, and applying business rules to ensure data consistency across integrated systems.

The integration module 140 may support both real-time and batch data synchronization modes. Real-time synchronization may enable immediate updates across systems, while batch processing may be used for large-scale data transfers or resource-intensive operations.

To manage the flow of data between systems, the integration module 140 may implement a robust queuing system. This system may help ensure reliable data delivery, handle retries in case of failures, and manage system load during peak usage periods.

The module 140 may include a comprehensive logging and monitoring system to track all integration activities. This system may provide detailed information about data transfers, error occurrences, and system performance, facilitating troubleshooting and optimization efforts.

To simplify the integration process for users, the integration module 140 may feature a user-friendly interface for configuring and managing integrations. This interface may include wizards for common integration scenarios and visual tools for mapping data fields between systems.

The integration module 140 may support bi-directional data synchronization, allowing for the exchange of information between the marketing taxonomy management platform 100 and external CRM systems, CMS platforms, and/or analytics tools in both directions. This may help ensure data consistency across all connected systems.

To handle potential conflicts during data synchronization, the integration module 140 may implement conflict resolution mechanisms. These mechanisms may include user-defined rules for determining which system takes precedence in case of conflicting data.

The module 140 may provide support for custom field mapping, allowing users to define how specific data fields in the marketing taxonomy management platform 100 correspond to fields in external CRM systems, CMS platforms, and/or analytics tools. This flexibility may accommodate diverse organizational data structures and naming conventions.

The integration module 140 may utilize various APIs for connecting with external CRM systems, CMS platforms, and/or analytics tools. These APIs may include RESTful APIs, SOAP APIs, or custom APIs provided by the CRM, CMS, and analytics tool vendors. The integration module 140 may support popular CRM systems such as Salesforce API, HubSpot API, and Microsoft Dynamics API; popular CMS platforms such as WordPress, Drupal, and Joomla; popular analytics tools may include Google Analytics, HubSpot, and Tableau.

Data mapping processes between the platform 100 and external CRM systems may be implemented using a flexible mapping engine. This engine may allow users to define custom field mappings between the platform's data model and the CRM system's data structure. The mapping engine may support one-to-one, one-to-many, and many-to-one field mappings.

Synchronization mechanisms may be implemented to ensure data consistency between the marketing taxonomy platform and integrated CRM systems, CMS platforms, and/or analytics tools. Real-time synchronization may be achieved through webhooks or polling mechanisms. The platform may also support scheduled batch synchronization at user-defined intervals. The frequency of synchronization may be configurable, allowing users to set up hourly, daily, or weekly sync schedules based on their needs.

To handle data conflicts or inconsistencies, the integration module 140 may implement conflict resolution strategies such as (but not limited to) last-write-wins (the most recent update takes precedence), source-of-truth (one system is designated as the authoritative source for specific data fields), and/or manual resolution (conflicts are flagged for manual review and resolution by users), The platform may maintain a detailed sync log to track all data transfer activities and any conflicts encountered during synchronization.

Security measures for data transfer between the marketing taxonomy platform and external CRM systems, CMS platforms, and/or analytics tools may include encryption of data in transit using TLS/SSL protocols. authentication mechanisms (e.g., OAuth 2.0) for secure API access. IP whitelisting to restrict API access to approved IP addresses, tokenization of sensitive data to minimize exposure of personally identifiable information, and/or security audits and penetration testing of the integration components.

The integration module 140 may implement rate limiting and throttling mechanisms to ensure compliance with API usage limits imposed by CRM, CMS, and/or analytics vendors. This may help prevent overloading of external systems and maintain stable connections.

To facilitate seamless data exchange, the platform 100 may implement a queueing system for asynchronous processing of large data volumes. This may help manage high-volume data transfers without impacting the performance of the core platform.

The integration module 140 may provide detailed logging and monitoring capabilities to track the health and performance of CRM, CMS, and/or analytics integrations. This may include real-time status dashboards, error notifications, and integration analytics to help administrators identify and resolve integration issues promptly.

### E. A Machine Learning Module

The platform 100 may include a machine learning module 150. The machine learning module 150 may include hardware and/or software configured to analyze user interaction patterns and provide automated data entry suggestions. The machine learning module 150 may be designed to improve efficiency and accuracy in managing marketing taxonomies.

The module 150 may employ supervised learning techniques to train on historical marketing campaign data. In some embodiments, the module 150 may analyze patterns in how a particular user structures and/or categorizes their campaigns, identifying common attributes and relationships. This training process may allow the module to recognize similarities in new campaign data and suggest appropriate categorizations. In other embodiments, the module 150 may analyze patterns across a plurality of users at a single organization, or across multiple organizations.

Natural language processing capabilities may be incorporated to interpret and classify textual campaign descriptions. The module 150 may extract key entities, themes, and intents from campaign text to suggest relevant taxonomy categories. This may help streamline the process of organizing campaigns into a coherent structure.

The machine learning module 150 may leverage unsupervised learning algorithms to discover latent patterns and groupings in marketing data. Clustering techniques may be applied to identify natural segments and hierarchies that emerge from the data. These insights may inform suggestions for optimizing taxonomy structures.

As users interact with the platform 100, the module 150 may refine models through reinforcement learning. The machine learning module 150 may track which suggestions are accepted or rejected by users to improve the relevance and accuracy of future recommendations. This adaptive approach may allow the platform 100 to become more tailored to each organization's unique taxonomy needs over time.

The module 150 may generate automated data entry suggestions in real-time as users input new campaign information. It may analyze partial entries and predict likely values for remaining fields based on historical patterns. This predictive capability may significantly reduce manual data entry time for users.

Advanced feature engineering techniques may be employed to extract meaningful attributes from raw campaign data. The module may identify complex relationships between various campaign elements to inform its suggestions. This may enable more nuanced and context-aware recommendations.

The machine learning module 150 may integrate with other platform components to enhance capabilities. The module 150 may leverage data from connected CRM systems, CMS platforms, and/or analytics tools to incorporate broader customer and campaign performance insights into its models. This holistic view may lead to more informed and effective taxonomy suggestions.

Various AI techniques may be implemented to provide transparency into the module's decision-making process. Users may be able to view the key factors influencing each suggestion, allowing them to understand and validate the recommendations. This transparency may build trust and enable users to provide feedback to further improve the machine learning module 150 and/or the platform 100 generally.

The module 150 may employ techniques to handle imbalanced datasets, ensuring that less common campaign types or categories are still accurately recognized and suggested. This may help maintain comprehensive taxonomy coverage across diverse marketing activities.

Periodic model retraining and validation processes may be implemented to ensure the machine learning module remains accurate and relevant as marketing trends evolve. The platform 100 may automatically detect when model performance begins to degrade and trigger updates accordingly.

The machine learning module 150 may be designed with scalability in mind, capable of efficiently processing large volumes of marketing data across multiple organizations. Distributed computing techniques may be utilized to handle increased loads as the platform grows.

Privacy-preserving machine learning approaches may be incorporated to protect sensitive campaign information while still enabling effective learning. Techniques such as federated learning or differential privacy may be employed to maintain data confidentiality.

The module 150 may include safeguards against potential biases in its suggestions, regularly auditing its outputs for fairness across different campaign types and user segments. This may help ensure equitable and unbiased taxonomy management for all users.

The machine learning module 150 may utilize various algorithms and techniques to enhance the system's capabilities. Specific machine learning algorithms used for taxonomy prediction may include decision trees, random forests, support vector machines, and/or any other algorithm useful for predicting taxonomies. These algorithms may be trained on historical marketing campaign data to predict taxonomy structures.

Feature engineering and selection processes may involve extracting relevant attributes from campaign data, such as keywords, target audience demographics, and performance metrics. Dimensionality reduction techniques like principal component analysis (PCA) may be applied to identify the most informative features for taxonomy prediction.

The model training pipeline may consist of data preprocessing, feature extraction, model selection, and hyperparameter tuning. Data requirements for effective training may include a diverse set of historical marketing campaigns with associated metadata and performance metrics. Cross-validation techniques may be employed to ensure model robustness and generalizability.

Evaluation metrics for the machine learning models may include accuracy, precision, recall, and F1 score. Performance criteria may be established based on industry benchmarks and specific business requirements. The system may continuously monitor model performance and trigger retraining when accuracy falls below a predetermined threshold.

Integration of machine learning predictions into the system may be achieved through an API layer that allows real-time querying of the trained models. The platform may incorporate a feedback loop mechanism to capture user interactions and campaign outcomes, which may be used to refine and improve the machine learning models over time.

The machine learning module 150 may implement natural language processing (NLP) techniques to analyze campaign descriptions and extract relevant keywords for taxonomy classification. Techniques such as word embeddings and topic modeling may be utilized to identify semantic relationships between campaign elements and suggest appropriate taxonomy structures.

Reinforcement learning algorithms may be employed to optimize taxonomy structures based on user feedback and campaign performance metrics. The system may learn to adapt its recommendations over time, taking into account the evolving nature of marketing strategies and user preferences.

In some embodiments, the platform 100 may implement a hybrid approach combining rule-based systems with machine learning models to leverage domain expertise while benefiting from data-driven insights. This approach may allow for greater interpretability of the model's decisions and facilitate easier integration with existing marketing workflows.

To help ensure scalability and performance, the machine learning module 150 may utilize distributed computing frameworks for model training and inference. The system may implement caching mechanisms to store frequently accessed predictions and reduce latency in taxonomy generation.

The platform 100 may provide visualization tools to help users understand the machine learning model's decision-making process and the factors influencing taxonomy predictions. These visualizations may include feature importance plots, decision trees, and confusion matrices to enhance transparency and user trust in the system's recommendations.

The machine learning module 150 may be implemented using a machine learning framework, such as (but not limited to) TensorFlow. The model architecture may include a deep neural network with multiple hidden layers. Hyperparameters such as learning rate, batch size, and number of epochs may be tuned through cross-validation to optimize performance.

The training data requirements for the machine learning model may include historical marketing campaign data, user interaction logs, and associated performance metrics. Preprocessing steps may involve data cleaning, normalization, and feature engineering to extract relevant inputs for the model. Natural language processing techniques may be applied to textual data to derive meaningful features.

To enable continuous learning and model updates, the platform may implement an online learning approach. New data points may be incrementally incorporated into the model as they become available. A feedback loop may be established to capture user interactions and campaign performance data, allowing the model to adapt to changing patterns over time.

The machine learning pipeline may include automated feature selection algorithms to identify the most relevant inputs for prediction tasks. Ensemble methods such as random forests or gradient boosting may be employed to improve model robustness and generalization.

To handle imbalanced datasets, which may be common in marketing contexts, techniques such as oversampling, undersampling, or synthetic data generation (e.g., SMOTE) may be applied during the training process. This may help ensure the model performs well across all classes or segments.

The platform may implement a model versioning system to track changes and allow for easy rollback if needed. A/B testing capabilities may be integrated to compare the performance of different model versions or architectures in real-world scenarios.

To address potential bias in the machine learning models, the platform may incorporate fairness-aware machine learning techniques. This may include preprocessing methods to mitigate bias in training data and post-processing approaches to adjust model outputs for fairness across different user segments.

The machine learning component may leverage transfer learning techniques to adapt pre-trained models to specific marketing domains or client datasets. This may allow for faster model development and improved performance, especially in cases with limited training data.

To enhance interpretability, the platform may incorporate explainable AI techniques such as SHAP (SHapley Additive explanations) values or LIME (Local Interpretable Model-agnostic Explanations). These methods may provide insights into feature importance and individual prediction explanations, helping users understand model decisions.

The machine learning infrastructure may be designed to scale horizontally, allowing for distributed training and inference across multiple machines or cloud instances. This may enable the platform to handle large-scale datasets and high-volume prediction requests efficiently.

### F. A Dashboard Generator

The platform 100 may include a dashboard generator 160. The dashboard generator 160 may include hardware and/or software configured to create customizable visualizations of marketing data and analytics. The dashboard generator 160 may utilize data from various sources within the platform to present meaningful insights to users.

The dashboard generator 160 may include a user interface that allows users to select and arrange different types of visualizations. These visualizations may include charts, graphs, tables, and other graphical representations of marketing campaign performance metrics. Users may be able to drag and drop different visualization components onto their dashboard canvas.

The generator 160 may connect to the platform's database to retrieve relevant marketing taxonomy and campaign data. It may process this raw data into a format suitable for visualization. The dashboard generator 160 may apply various data aggregation and analysis techniques to derive insights from the underlying data.

Real-time data updates may be supported by the dashboard generator. As new marketing campaign data becomes available in the system, the visualizations may automatically refresh to reflect the latest information. This may allow users to monitor campaign performance in near real-time.

Customization options may be provided to allow users to tailor the dashboard to their specific needs. Users may be able to filter data, adjust time ranges, and modify the appearance of individual visualization components. The dashboard generator may save these customizations on a per-user basis.

The generator 160 may incorporate responsive design principles to ensure the dashboard renders properly across different device types and screen sizes. This may allow users to access their marketing insights from desktop computers, tablets, or mobile devices.

Export functionality may be included to allow users to download or share dashboard visualizations. The generator 160 may support exporting to various file formats such as PDF, PNG, or CSV.

Integration with the platform's machine learning capabilities (e.g., via the machine learning module 150) may allow the dashboard generator 160 to provide predictive analytics and automated insights. It may highlight trends, anomalies, or opportunities within the marketing data that may not be immediately apparent to users.

### G. A Data Import/Export Module

In some embodiments, the platform 100 may include a data import/export module 170. The data import/export module 170 may include hardware and/or software to facilitate the transfer of marketing taxonomy and campaign data between the platform 100 and one or more external systems. The module 170 may provide functionality for importing data from various sources and/or exporting data to various destinations and/or in different formats to meet user needs.

The import capabilities of the module 170 may allow users to bring existing marketing data into the platform 100. The module 170 may support importing data from common file formats such as CSV, Excel spreadsheets, and/or JSON formats. In some embodiments, the module 170 may also provide options to connect directly to external marketing platforms, customer relationship management (CRM) systems, content management system (CMS) platforms, and/or analytics tools to pull in relevant data.

When importing data, the module 170 may perform validation checks to ensure data integrity and consistency with a data model of the platform 100. This may include, as non-limiting examples, verifying required fields, checking data types, and/or identifying potential duplicates. The module 170 may provide users with feedback on data quality issues detected during the import process.

For data export, the module 170 may offer options to extract marketing taxonomy and campaign data from the platform 100. Users may be able to select specific data elements or entire datasets to export. The module 170 may support exporting to various file formats to accommodate different user needs and downstream systems.

The data import/export module 170 may include a user interface that guides users through the import and export processes. This interface may allow users to map fields from their source data to the corresponding fields in the existing data model. The interface may provide options for scheduling automated imports and/or exports on a recurring basis.

To ensure data security, the module 170 may implement encryption for data in transit and integrate with the platform's authentication and authorization systems. It may log all import and export activities for auditing purposes.

The module 170 may be designed with extensibility in mind, allowing for the addition of new import/export connectors or file format support in the future. This may enable the platform 100 to adapt to evolving data exchange requirements in the marketing technology ecosystem.

### H. A Tracking Code Management Module

In embodiments, the platform 100 may optionally include a tracking code management module 180. The tracking code management module 180 may include hardware and/or software configured to generate and/or manage tracking codes used to track performance of a marketing campaign (e.g., a digital marketing campaign). As one particular example, the tracking code management module 180 may be used to generate and/or manage Urchin Tracking Module (UTM) codes.

The module 180 may be designed to generate, track, and analyze UTM codes and/or other tracking codes for marketing campaigns within the marketing taxonomy management platform 100. This module 180 may provide users with tools to create, organize, and monitor tracking codes associated with specific marketing taxonomy elements.

The tracking code management module 180 may include a code generator that automatically creates tracking codes (e.g., UTM codes) based on predefined parameters. These parameters may include, as non-limiting examples, campaign source, medium, name, term, and content. The generator may ensure that each tracking code adheres to best practices and maintains consistency across campaigns.

Users may be able to associate tracking codes with specific elements of the marketing taxonomy, such as campaigns, channels, and/or target audiences. This association may allow for more granular tracking and analysis of marketing efforts within the taxonomy structure.

The module 180 may provide a user interface for managing tracking codes, allowing users to view, edit, and delete existing codes. This interface may include search and filter functionalities to help users quickly locate specific tracking codes within large campaigns.

To facilitate tracking, the tracking code management module 180 may integrate with web analytics tools and other marketing platforms. This integration may enable the automatic collection of data related to tracking code performance, such as click-through rates, conversion rates, and revenue attribution.

The module 180 may include a reporting feature that generates analytics based on tracking code performance. These reports may include visualizations such as charts and graphs to help users understand the effectiveness of different campaigns and channels.

To support collaboration and version control, the tracking code management module 180 may implement a change tracking system. This system may log modifications to tracking codes, including who made the changes and when, allowing teams to maintain a clear history of campaign tracking efforts.

The module 180 may offer bulk operations for tracking code management, such as importing or exporting large sets of codes. This feature may be particularly useful for users managing multiple campaigns or working with external agencies.

To enhance user productivity, the tracking code management module 180 may include templates and presets for commonly used tracking code structures. Users may be able to create and save custom templates tailored to their specific marketing needs.

The module 180 may implement validation checks to ensure that tracking codes are properly formatted and comply with best practices. This may help prevent errors in tracking and improve the overall quality of campaign data.

To support multi-channel marketing efforts, the tracking code management module 180 may allow for the creation of unique codes for different marketing channels, such as email, social media, and paid advertising. This may enable more accurate attribution of marketing efforts across various platforms.

The module 180 may include a feature for generating shortened URLs with embedded tracking codes, making it easier to share trackable links on platforms with character limitations.

The tracking code management module 170 may be responsible for generating and managing UTM codes associated with the marketing taxonomy. This module 170 may employ a sophisticated algorithm for generating unique UTM codes. The algorithm may incorporate elements such as campaign identifiers, source information, and timestamp data to ensure each generated code is unique and traceable.

The data structure for storing UTM code information may be designed to efficiently handle large volumes of tracking data. It may utilize a combination of relational and non-relational database technologies to optimize storage and retrieval of UTM code information. The structure may include fields for the UTM code itself, associated campaign details, creation timestamp, and usage statistics.

The process for associating UTM codes with taxonomy elements may involve creating logical links between each UTM code and the corresponding elements in the marketing taxonomy. This association may be stored in a separate mapping table or embedded within the taxonomy structure itself, allowing for quick retrieval and analysis of campaign performance in relation to specific taxonomy elements.

Tracking mechanisms for UTM code usage may be implemented to monitor the utilization of each generated code. These mechanisms may include real-time tracking of code activations, recording of user interactions associated with each code, and aggregation of usage statistics over time. The tracking data may be stored in a scalable, distributed database system to handle high volumes of concurrent tracking events.

Analysis techniques for UTM code performance metrics may be implemented to provide valuable insights into campaign effectiveness. These techniques may include statistical analysis of code usage patterns, correlation analysis between UTM code performance and taxonomy elements, and predictive modeling to forecast future campaign performance based on historical UTM code data.

The UTM code management module 170 may also provide functionality for bulk generation of UTM codes for large-scale campaigns. This feature may allow users to specify parameters for multiple codes and generate them in batches, streamlining the process for complex marketing initiatives.

Integration capabilities may be implemented to allow the UTM code management module 170 to seamlessly exchange data with popular analytics platforms. This integration may enable automatic import of UTM code performance data from external sources, enriching the platform's analytics capabilities and providing a more comprehensive view of campaign performance.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 400 may be employed in the performance of some or all of the stages disclosed with regard to the methods. Similarly, an apparatus may be employed in the performance of some or all of the stages of the methods. As such, the apparatus may comprise at least those architectural components found in computing device 400.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the method without altering or departing from the fundamental scope of the depicted methods and systems disclosed herein.

### A. Master Method

Consistent with embodiments of the present disclosure, a method may be performed by at least one of the aforementioned modules. The method may be embodied as, for example, but not limited to, computer instructions, which, when executed, perform the method.

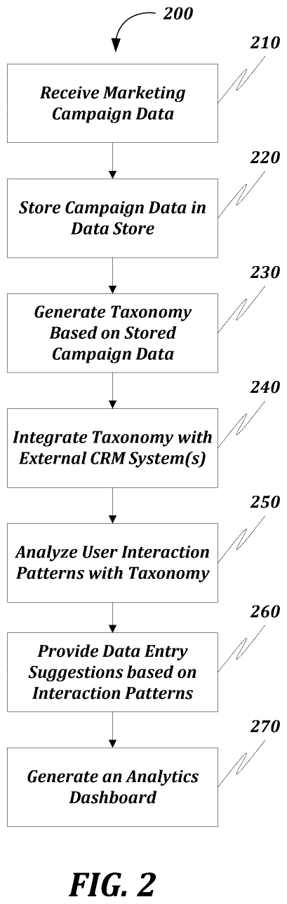

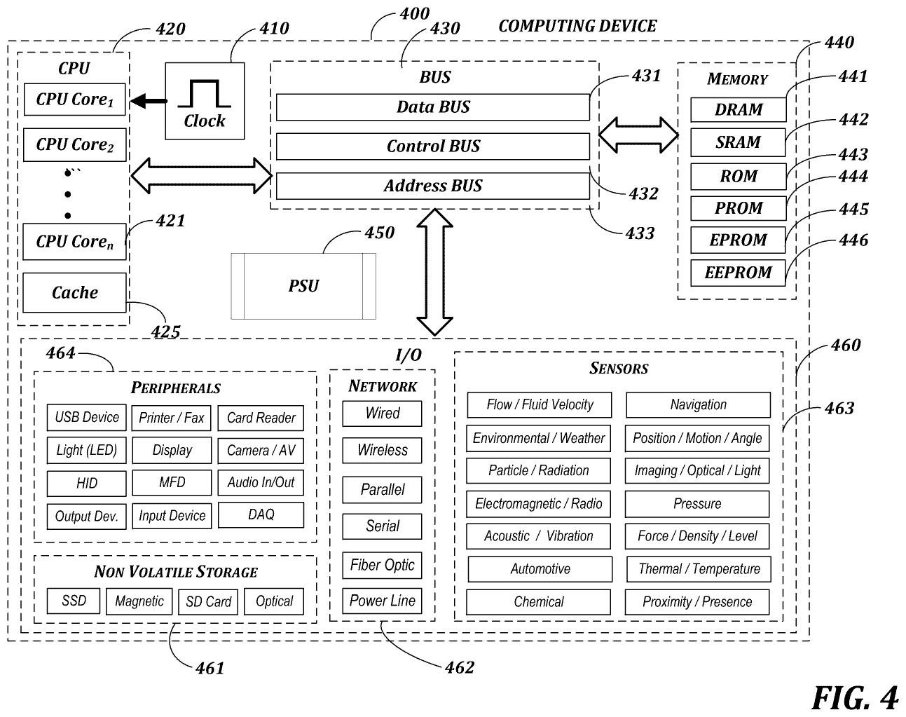

FIG. 2 is a flow chart setting forth the general stages involved in a method 200 consistent with an embodiment of the disclosure for providing marketing campaign management platform 100. Method 200 may be implemented using a computing device 400 or any other component associated with platform 100 as described in more detail below with respect to FIG. 4. For illustrative purposes alone, computing device 400 is described as one potential actor in the following stages.

Method 200 may begin with stage 210 where the computing device receives marketing campaign data from a user. This data may be input through a user interface of the platform 100, such as forms with clearly labeled fields for entering campaign details like name, description, start and end dates, budget, and target audience.

Stage 220 may involve storing the received marketing campaign data in a structured database. The data store 130 may utilize a distributed database system to ensure scalability and high performance, capable of handling concurrent read and write operations from multiple users and integrated systems.

In stage 230, the computing device may generate a marketing taxonomy based on the stored marketing campaign data. The taxonomy generation module 120 may employ advanced algorithms and machine learning techniques to analyze the stored data, identifying patterns, relationships, and commonalities among various marketing elements to create a logical and efficient taxonomy structure.

Stage 240 may involve integrating the marketing taxonomy with at least one external customer relationship management (CRM) system. The integration module 140 may utilize standardized application programming interfaces (APIs) to establish connections with various external systems, such as Salesforce or HubSpot.

In stage 250, the computing device may analyze user interaction patterns with the marketing taxonomy. The machine learning module 150 may employ supervised learning techniques to analyze patterns in how users structure and categorize their campaigns, identifying common attributes and relationships.

Stage 260 may involve providing automated data entry suggestions based on the analyzed user interaction patterns. The machine learning module 150 may generate these suggestions in real-time as users input new campaign information, analyzing partial entries and predicting likely values for remaining fields based on historical patterns.

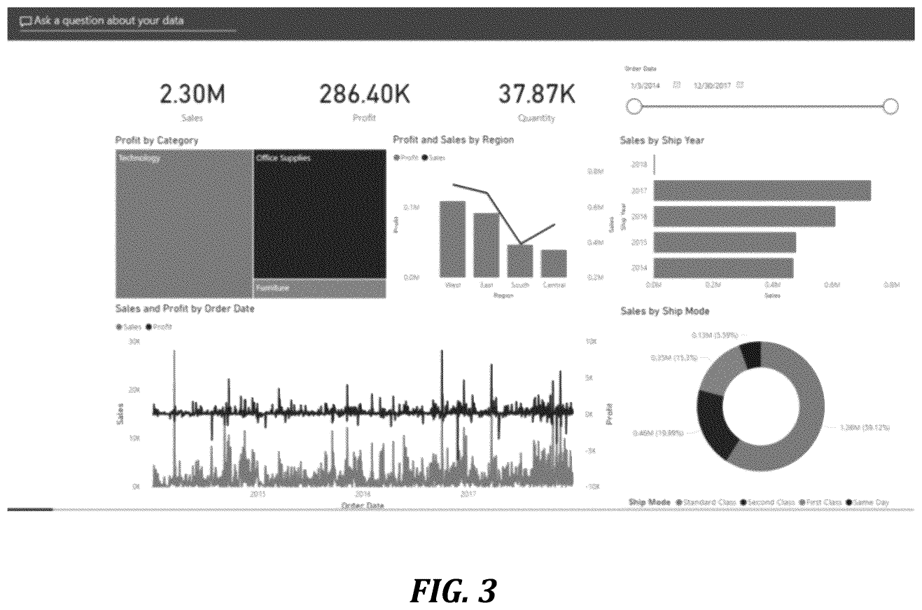

Finally, in stage 270, the computing device may generate a customizable analytics dashboard based on the marketing taxonomy and the integrated CRM data, as shown in FIG. 3. The dashboard generator 160 may create visualizations of marketing data and analytics, utilizing data from various sources within the platform to present meaningful insights to users.

The method 200 may further include additional stages. For example, the computing device may receive user input to customize the analytics dashboard and update it based on the received input. This may involve allowing users to select and arrange different types of visualizations, such as charts, graphs, and tables.

Another stage may involve executing a machine learning model to predict optimal marketing taxonomy structures based on historical data and user interactions. The machine learning module 150 may leverage unsupervised learning algorithms to discover latent patterns and groupings in marketing data.

The method 200 may also include synchronizing the marketing taxonomy data with the integrated CRM system in real-time. This may be facilitated by the integration module 140, which may support both real-time and batch data synchronization modes.

An additional stage may involve implementing a user authentication and access control system to manage user accounts and permissions for accessing the marketing taxonomy. This may be part of the platform's security infrastructure, which may include encryption of data at rest and in transit, multi-factor authentication, and regular security audits.

The method 200 may further include generating performance metrics for marketing campaigns associated with the marketing taxonomy and displaying these metrics on the customizable analytics dashboard. This may involve processing raw data into a format suitable for visualization and applying various data aggregation and analysis techniques to derive insights.

In some embodiments, the method 200 may include stages for managing Urchin Tracking Module (UTM) codes and/or other tacking codes. This may involve generating and tracking codes for marketing campaigns, associating them with specific marketing taxonomy elements, and analyzing tracking code performance in relation to campaign metrics.

Throughout the execution of method 200, the platform 100 may employ various techniques to ensure data security and privacy. This may include implementing robust encryption protocols for all communications between the platform and external systems, and adhering to industry standards for security and compliance.

The method 200 may also include stages for data import and export. This may involve supporting the import of marketing campaign data from external sources in various formats, and the export of marketing taxonomy data to external systems in user-specified formats. The data import/export module 170 may perform validation checks to ensure data integrity and consistency with the platform's data model.

### IV. Hardware Architecture

Platform 100 may be hosted on a centralized server or a cloud computing service. Although method 200 has been described to be performed by a computing device 400, it should be understood that, in some embodiments, different operations may be performed by a plurality of the computing devices 400 in operative communication on at least one network.

Embodiments of the present disclosure may comprise a system having a central processing unit (CPU) 420, a bus 430, a memory unit 440, a power supply unit (PSU) 450, and one or more Input/Output (I/O) units. The CPU 420 coupled to the memory unit 440 and the plurality of I/O units 460 via the bus 430, all of which are powered by the PSU 450. It should be understood that, in some embodiments, each disclosed unit may actually be a plurality of such units for redundancy, high availability, and/or performance purposes. The combination of the presently disclosed units is configured to perform the stages of any method disclosed herein.

FIG. 4 is a block diagram of a system including computing device 400. Consistent with an embodiment of the disclosure, the aforementioned CPU 420, the bus 430, the memory unit 440, a PSU 450, and the plurality of I/O units 460 may be implemented in a computing device, such as computing device 400 of FIG. 4. Any suitable combination of hardware, software, or firmware may be used to implement the aforementioned units. For example, the CPU 420, the bus 430, and the memory unit 440 may be implemented with computing device 400 or any of other computing devices 400, in combination with computing device 400. The aforementioned system, device, and components are examples and other systems, devices, and components may comprise the aforementioned CPU 420, the bus 430, and the memory unit 440, consistent with embodiments of the disclosure.

At least one computing device 400 may be embodied as any of the computing elements illustrated in all of the attached figures. A computing device 400 does not need to be electronic, nor even have a CPU 420, nor bus 430, nor memory unit 440. The definition of the computing device 400 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 400, especially if the processing is purposeful.

With reference to FIG. 4, a system consistent with an embodiment of the disclosure may include a computing device, such as computing device 400. In some configurations, the computing device 400 may include at least one clock module 410, at least one CPU 420, at least one bus 430, and at least one memory unit 440, at least one PSU 450, and at least one I/O 460 module, wherein I/O module may be comprised of, but not limited to a non-volatile storage sub-module 461, a communication sub-module 462, a sensors sub-module 463, and a peripherals sub-module 464.

In a system consistent with an embodiment of the disclosure, the computing device 400 may include the clock module 410, known to a person having ordinary skill in the art as a clock generator, which produces clock signals. Clock signals may oscillate between a high state and a low state at a controllable rate, and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 420, the central component of modern computers, which relies on a clock signal. The clock 410 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 400 may use a “clock multiplier” which multiplies a lower frequency external clock to the appropriate clock rate of the CPU 420. This allows the CPU 420 to operate at a much higher frequency than the rest of the computing device 400, which affords performance gains in situations where the CPU 420 does not need to wait on an external factor (like memory 440 or input/output 460). Some embodiments of the clock 410 may include dynamic frequency change, where, the time between clock edges can vary widely from one edge to the next and back again.

In a system consistent with an embodiment of the disclosure, the computing device 400 may include the CPU 420 comprising at least one CPU Core 421. In other embodiments, the CPU 420 may include a plurality of identical CPU cores 421, such as, but not limited to, homogeneous multi-core systems. It is also possible for the plurality of CPU cores 421 to comprise different CPU cores 421, such as, but not limited to, heterogeneous multi-core systems, big.LITTLE systems and some AMD accelerated processing units (APU). The CPU 420 reads and executes program instructions which may be used across many application domains, for example, but not limited to, general purpose computing, embedded computing, network computing, digital signal processing (DSP), and graphics processing (GPU). The CPU 420 may run multiple instructions on separate CPU cores 421 simultaneously. The CPU 420 may be integrated into at least one of a single integrated circuit die, and multiple dies in a single chip package. The single integrated circuit die and/or the multiple dies in a single chip package may contain a plurality of other elements of the computing device 400, for example, but not limited to, the clock 410, the bus 430, the memory 440, and I/O 460.

The CPU 420 may contain cache 422 such as but not limited to a level 1 cache, a level 2 cache, a level 3 cache, or combinations thereof. The cache 422 may or may not be shared amongst a plurality of CPU cores 421. The cache 422 sharing may comprise at least one of message passing and inter-core communication methods used for the at least one CPU Core 421 to communicate with the cache 422. The inter-core communication methods may comprise, but not be limited to, bus, ring, two-dimensional mesh, and crossbar. The aforementioned CPU 420 may employ symmetric multiprocessing (SMP) design.

The one or more CPU cores 421 may comprise soft microprocessor cores on a single field programmable gate array (FPGA), such as semiconductor intellectual property cores (IP Core). The architectures of the one or more CPU cores 421 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 421, for example, but not limited to Instruction-level parallelism (ILP) such as, but not limited to, superscalar pipelining, and Thread-level parallelism (TLP).

Consistent with the embodiments of the present disclosure, the aforementioned computing device 400 may employ a communication system that transfers data between components inside the computing device 400, and/or the plurality of computing devices 400. The aforementioned communication system will be known to a person having ordinary skill in the art as a bus 430. The bus 430 may embody internal and/or external hardware and software components, for example, but not limited to a wire, an optical fiber, various communication protocols, and/or any physical arrangement that provides the same logical function as a parallel electrical bus. The bus 430 may comprise at least one of a parallel bus, wherein the parallel bus carries data words in parallel on multiple wires; and a serial bus, wherein the serial bus carries data in bit-wise serial form. The bus 430 may embody a plurality of topologies, for example, but not limited to, a multidrop/electrical parallel topology, a daisy chain topology, and connected by switched hubs, such as a USB bus. The bus 430 may comprise a plurality of embodiments, for example, but not limited to:
Internal data bus (data bus) 431/Memory bus
Control bus 432
Address bus 433
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)·
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect extended (PCI-X), Peripheral Component Interconnect Express (PCIe) (e.g., PCI Express Mini Card, PCI Express M.2 [Mini PCIe v2], PCI Express External Cabling [ePCle], and PCI Express OCuLink [Optical Copper {Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)·
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and extensible Host Controller Interface (xHCI).

Consistent with the embodiments of the present disclosure, the aforementioned computing device 400 may employ hardware integrated circuits that store information for immediate use in the computing device 400, known to persons having ordinary skill in the art as primary storage or memory 440. The memory 440 operates at high speed, distinguishing it from the non-volatile storage sub-module 461, which may be referred to as secondary or tertiary storage, which provides relatively slower-access to information but offers higher storage capacity. The data contained in memory 440 may be transferred to secondary storage via techniques such as, but not limited to, virtual memory and swap. The memory 440 may be associated with addressable semiconductor memory, such as integrated circuits consisting of silicon-based transistors, that may be used as primary storage or for other purposes in the computing device 400. The memory 440 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 441, Static Random-Access Memory (SRAM) 442, CPU Cache memory 425, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 443, Programmable ROM (PROM) 444, Erasable PROM (EPROM) 445, Electrically Erasable PROM (EEPROM) 446 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 400 may employ a communication system between an information processing system, such as the computing device 400, and the outside world, for example, but not limited to, human, environment, and another computing device 400. The aforementioned communication system may be known to a person having ordinary skill in the art as an Input/Output (I/O) module 460. The I/O module 460 regulates a plurality of inputs and outputs with regard to the computing device 400, wherein the inputs are a plurality of signals and data received by the computing device 400, and the outputs are the plurality of signals and data sent from the computing device 400. The I/O module 460 interfaces with a plurality of hardware, such as, but not limited to, non-volatile storage 461, communication devices 462, sensors 463, and peripherals 464. The plurality of hardware is used by at least one of, but not limited to, humans, the environment, and another computing device 400 to communicate with the present computing device 400. The I/O module 460 may comprise a plurality of forms, for example, but not limited to channel I/O, port mapped I/O, asynchronous I/O, and Direct Memory Access (DMA).

Consistent with the embodiments of the present disclosure, the aforementioned computing device 400 may employ a non-volatile storage sub-module 461, which may be referred to by a person having ordinary skill in the art as one of secondary storage, external memory, tertiary storage, off-line storage, and auxiliary storage. The non-volatile storage sub-module 461 may not be accessed directly by the CPU 420 without using an intermediate area in the memory 440. The non-volatile storage sub-module 461 may not lose data when power is removed and may be orders of magnitude less costly than storage used in memory 440. Further, the non-volatile storage sub-module 461 may have a slower speed and higher latency than in other areas of the computing device 400. The non-volatile storage sub-module 461 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (461) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 400 may employ a communication sub-module 462 as a subset of the I/O module 460, which may be referred to by a person having ordinary skill in the art as at least one of, but not limited to, a computer network, a data network, and a network. The network may allow computing devices 400 to exchange data using connections, which may also be known to a person having ordinary skill in the art as data links, which may include data links between network nodes. The nodes may comprise networked computer devices 400 that may be configured to originate, route, and/or terminate data. The nodes may be identified by network addresses and may include a plurality of hosts consistent with the embodiments of a computing device 400. Examples of computing devices that may include a communication sub-module 462 include, but are not limited to, personal computers, phones, servers, drones, and networking devices such as, but not limited to, hubs, switches, routers, modems, and firewalls.

Two nodes can be considered networked together when one computing device 400 can exchange information with the other computing device 400, regardless of any direct connection between the two computing devices 400. The communication sub-module 462 supports a plurality of applications and services, such as, but not limited to World Wide Web (WWW), digital video and audio, shared use of application and storage computing devices 400, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPV6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 462 may comprise a plurality of size, topology, traffic control mechanisms and organizational intent policies. The communication sub-module 462 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 400 may employ a sensors sub-module 463 as a subset of the I/O 460. The sensors sub-module 463 comprises at least one of the device, module, or subsystem whose purpose is to detect events or changes in its environment and send the information to the computing device 400. Sensors may be sensitive to the property they are configured to measure, may not be sensitive to any property not measured but be encountered in its application, and may not significantly influence the measured property. The sensors sub-module 463 may comprise a plurality of digital devices and analog devices, wherein if an analog device is used, an Analog to Digital (A-to-D) converter must be employed to interface the said device with the computing device 400. The sensors may be subject to a plurality of deviations that limit sensor accuracy. The sensors sub-module 463 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (02), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 400 may employ a peripherals sub-module 464 as a subset of the I/O 460. The peripheral sub-module 464 comprises ancillary devices used to put information into and get information out of the computing device 400. There are 3 categories of devices comprising the peripheral sub-module 464, which exist based on their relationship with the computing device 400, input devices, output devices, and input/output devices. Input devices send at least one of data and instructions to the computing device 400. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 400. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 464:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   degree of freedom devices, that require up to six degrees of freedom such as, but not limited to, camera gimbals, Cave Automatic Virtual Environment (CAVE), and virtual reality systems.
   Input devices are used to digitize images or video from the outside world into the computing device 400. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 400 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 400. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network sub-module 462), data storage devices (non-volatile storage 461), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A method for managing marketing taxonomy, the method comprising:
receiving, by a computing device, marketing campaign data from a user;
storing the marketing campaign data in a structured database;
generating, by the computing device, a marketing taxonomy based on the stored marketing campaign data;
integrating the marketing taxonomy with at least one external customer relationship management (CRM) system;
analyzing, by the computing device, user interaction patterns with the marketing taxonomy;
providing, by the computing device, automated data entry suggestions based on the analyzed user interaction patterns; and
generating, by the computing device, a customizable analytics dashboard based on the marketing taxonomy and the integrated CRM data.

2. The method of claim 1, further comprising:
receiving, by the computing device, user input to customize the analytics dashboard; and
updating the analytics dashboard based on the received user input.

3. The method of claim 1, wherein the at least one external CRM system comprises Salesforce or HubSpot.

4. The method of claim 1, further comprising:
executing, by the computing device, a machine learning model to predict optimal marketing taxonomy structures based on historical data and user interactions.

5. The method of claim 1, further comprising:
synchronizing, by the computing device, the marketing taxonomy data with the integrated CRM system in real-time.

6. The method of claim 1, further comprising:
implementing, by the computing device, a user authentication and access control system to manage user accounts and permissions for accessing the marketing taxonomy.

7. The method of claim 1, further comprising:
generating, by the computing device, performance metrics for marketing campaigns associated with the marketing taxonomy; and
displaying the performance metrics on the customizable analytics dashboard.

8. A non-transitory computer-readable medium storing instructions that, when executed by a processor, cause the processor to perform operations comprising:
receiving marketing campaign data from a user;
storing the marketing campaign data in a structured database;
generating a marketing taxonomy based on the stored marketing campaign data;
integrating the marketing taxonomy with at least one external customer relationship management (CRM) system;
analyzing user interaction patterns with the marketing taxonomy;
providing automated data entry suggestions based on the analyzed user interaction patterns; and
generating a customizable analytics dashboard based on the marketing taxonomy and the integrated CRM data.

9. The non-transitory computer-readable medium of claim 8, wherein the operations further comprise:
receiving user input to customize the analytics dashboard; and
updating the analytics dashboard based on the received user input.

10. The non-transitory computer-readable medium of claim 8, wherein the at least one external CRM system comprises Salesforce or HubSpot.

11. The non-transitory computer-readable medium of claim 8, wherein the operations further comprise:
executing a machine learning model to predict optimal marketing taxonomy structures based on historical data and user interactions.

12. The non-transitory computer-readable medium of claim 8, wherein the operations further comprise:
synchronizing the marketing taxonomy data with the integrated CRM system in real-time.

13. The non-transitory computer-readable medium of claim 8, wherein the operations further comprise:
implementing a user authentication and access control system to manage user accounts and permissions for accessing the marketing taxonomy.

14. The non-transitory computer-readable medium of claim 8, wherein the operations further comprise:
generating performance metrics for marketing campaigns associated with the marketing taxonomy; and
displaying the performance metrics on the customizable analytics dashboard.

15. A system for managing marketing taxonomy, comprising:
a cloud-based software platform;
a database configured to store marketing taxonomy data;
a user interface configured to receive user input for creating and managing marketing campaigns;
an integration module configured to connect with external customer relationship management (CRM) systems;
a machine learning component configured to analyze user interaction patterns and provide automated data entry suggestions;
a dashboard generator configured to create customizable visualizations of marketing data; and
a processor configured to:
receive marketing campaign data from the user interface;
store the marketing campaign data in the database;
synchronize the marketing campaign data with the connected external CRM systems;
analyze the marketing campaign data using the machine learning component;
generate automated data entry suggestions based on the analysis; and
generate customized dashboards displaying marketing campaign performance metrics.

16. The system of claim 15, wherein the integration module is further configured to:
establish connections with multiple external CRM systems simultaneously; and
synchronize data bidirectionally between the marketing taxonomy system and the connected external CRM systems.

17. The system of claim 15, wherein the machine learning component is further configured to:
predict optimal marketing taxonomy structures based on historical campaign data; and
continuously improve its predictions based on user interactions and campaign performance data.

18. The system of claim 15, wherein the dashboard generator is further configured to:
generate real-time analytics reports based on the marketing campaign data; and
allow users to customize dashboard views according to their specific needs.

19. The system of claim 15, further comprising a data import/export module configured to:
import marketing campaign data from external sources in various formats;
export marketing taxonomy data to external systems in user-specified formats; and
validate and cleanse imported data to ensure data integrity.

20. The system of claim 15, further comprising an Urchin Tracking Module (UTM) code management module configured to:
generate and track UTM codes for marketing campaigns;
associate UTM codes with specific marketing taxonomy elements; and
analyze UTM code performance in relation to campaign metrics.
